(19) United States
(12) Patent Application Publication
(10) Pub. No.: US 2026/0252781 A1
(43) Pub. Date: Aug. 27, 2026

(54) OPTIMIZED COORDINATE-BASED ROUTING IN HETEROGENEOUS NETWORK ON CHIP TOPOLOGIES

(71) Applicant: Baya Systems, Inc., Santa Clara, CA (US)

(72) Inventor: Eric NORIGE, Santa Clara, CA (US)

(21) Appl. No.: 19/063,133

(22) Filed: Feb. 25, 2025

(51) Int. Cl. G06F 30/394; G06F 15/78; G06F 115/02

(52) U.S. Cl. CPC G06F 30/394; G06F 15/7825; G06F 2115/02

(57) ABSTRACT

Aspects of the present disclosure are directed to a method and a system for optimized coordinate-based routing in a Network on Chip (NoC). The method includes identifying coordinate dimensions of a NoC, and transforming router connectivity of the NoC into aligned sequences for each coordinate dimension. Then, the method includes assigning order dependencies to the aligned sequences for the each coordinate dimension, and assigning coordinate identifiers to the aligned sequences based on the order dependencies. Further, the method includes assigning router coordinates according to the coordinate identifiers of the aligned sequences. Assigning router coordinates based on the order dependencies of the aligned sequences reduces the size of routes/paths between routers, thereby optimally utilizing the capabilities of the NoC and/or reducing cost.

### BACKGROUND

### Technical Field

Methods and example embodiments described herein are generally directed to a Network on Chip (NoC), and more specifically, to an optimized coordinate-based routing in heterogeneous NoCs.

### Related Art

The number of components on a chip is rapidly growing due to increasing levels of integration, system complexity, and shrinking transistor geometry. Complex System-on-Chips (SoCs) may involve a variety of components, e.g., processor cores, Digital Signal Processors (DSPs), hardware accelerators, memory, and Input/Output (I/O) interfaces, while Chip Multi-Processors (CMPs) may involve a large number of homogenous processor cores, memory, and I/O subsystems. In both systems, the on-chip interconnect plays a key role in providing high-performance communication between the various components. Due to scalability limitations of traditional buses and crossbar-based interconnects, Network-on-Chip (NoC) has emerged as a paradigm to interconnect a large number of components on the chip.

The NoC is a global shared communication infrastructure made up of several routing nodes interconnected with each other using point-to-point physical links. Messages are injected by source components and are routed from source router/nodes to a destination router/node over multiple intermediate nodes and physical links. The destination router/node then ejects the message to a destination component. For the remainder of the present disclosure, the terms ‘processing elements,’ ‘components,’ ‘endpoints,’ ‘blocks,’ ‘hosts,’ ‘agents,’ or ‘cores,’ will be used interchangeably to refer to the various system components that are interconnected using a NoC. The terms ‘routers’ and ‘nodes’ will also be used interchangeably. Without loss of generalization, a system with multiple interconnected components will itself be referred to as a ‘multi-core system’.

There are several possible topologies in which the routers can connect to one another to create the system network. Bi-directional rings 100A (as shown in FIG. 1A) and 2-D mesh 100B (as shown in FIG. 1B) are examples of topologies in the related art.

Packets are message transport units for intercommunication between various components. Routing involves identifying a path, which is a set of routers and physical links of the network over which packets are sent from a source component to a destination component. Components are connected to one or multiple ports of one or multiple routers; with each such port having a unique identifier (ID). Packets carry the destination's router and port ID for use by the intermediate routers to route the packet to the destination component.

Examples of routing techniques include deterministic/static routing, which involves choosing the same path from component A to component B for every packet. This form of routing is oblivious to the state of the network and does not load balance across path diversities which may exist in the underlying network. However, such deterministic routing may be simple to implement in hardware, maintains packet ordering, and may be easy to make free of network-level deadlocks. Shortest path routing minimizes the latency as it reduces the number of hops from the source component to the destination component. For this reason, the shortest path is also the lowest power path for communication between the two components. Dimension-order routing is a form of deterministic shortest-path routing in 2D mesh networks.

FIG. 2 illustrates an example of XY routing in a two-dimensional mesh 200. More specifically, FIG. 2 illustrates XY routing from node ‘34’ to node ‘00’. In the example of FIG. 2, each component is connected to only one port of one router. A packet is first routed in the X dimension until the packet reaches node ‘04’ where the X dimension is the same as that of the destination. The packet is next routed in the Y dimension until the packet reaches the destination node.

Source routing and routing using tables are other routing options used in NoC. Adaptive routing can dynamically change the path taken between two points on the network based on the state of the network. This form of routing may be complex to analyze and implement and is therefore rarely used in practice.

The NoC may contain multiple physical networks. Over each physical network, there may exist multiple virtual networks, where different message types are transmitted over different virtual networks. In this case, at each physical link or channel, there are multiple virtual channels (VCs), each of which may have dedicated buffers at both endpoints. In any given clock cycle, only one VC can transmit data on the physical channel.

NoC interconnects often employ wormhole routing, where a large message or packet is broken into small pieces known as flits (also referred to as flow control units). The first flit is the header flit which holds information about the packet's route and key message level information along with payload data and sets up the routing behavior for all subsequent flits associated with the message. Zero or more body flits follow the head flit, containing the remaining payload of data. The final flit is a tail flit, which in addition to containing the last payload, also performs some bookkeeping to close the connection for the message. In wormhole flow control, VCs are often implemented.

The physical channels are time-sliced into a number of independent logical channels, i.e. VCs. VCs provide multiple independent paths to route packets; however, they are time-multiplexed on the physical channels. A VC holds the state needed to coordinate the handling of the flits of a packet over a channel. At a minimum, this state identifies the output channel of the current node for the next hop of the route and the state of the virtual channel (idle, waiting for resources, or active). The VC may also include pointers to the flits of the packet that are buffered on the current node and the number of flit buffers available on the next node.

The term “wormhole” refers to the way messages are transmitted over the channels. The output port at the next router can be so short that received data can be translated in the head flit before the full message arrives. This allows the router to quickly set up the route upon arrival of the head flit and then opt-out from the rest of the conversation. Since a message is transmitted flit by flit, the message may occupy several flit buffers along its path at different routers, creating a worm-like image.

Based on the traffic between various endpoints, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies. However, all channels are equal in width or number of physical wires. This width can be determined based on the most loaded channel and the clock frequency of various channels.

### SUMMARY

Aspects of the present disclosure are directed to a method of designing a Network on Chip (NoC). The method includes identifying coordinate dimensions of a NoC and transforming router connectivity of the NoC into aligned sequences for each coordinate dimension. Then, the method includes assigning order dependencies to the aligned sequences for each coordinate dimension, and assigning coordinate identifiers to the aligned sequences based on the order dependencies. Further, the method includes assigning router coordinates according to the coordinate identifiers of the aligned sequences.

Other aspects of the present disclosure are directed to a system including a processor configured to identify coordinate dimensions of a NoC and transform router connectivity of the NoC into aligned sequences for each coordinate dimension. Then, the processor is configured to assign order dependencies to the aligned sequences for each coordinate dimension and assign coordinate identifiers to the aligned sequences based on the order dependencies. Further, the processor is configured to assign router coordinates according to the coordinate identifiers of the aligned sequences.

Further aspects of the present disclosure are directed to a computer-readable medium including instructions of designing a NoC. The instructions include identifying coordinate dimensions of a NoC and transforming router connectivity of the NoC into aligned sequences for each coordinate dimension. The instructions also include assigning order dependencies to the aligned sequences for each coordinate dimension, and assigning coordinate identifiers to the aligned sequences based on the order dependencies. Further, the instructions include assigning router coordinates according to the coordinate identifiers of the aligned sequences.

### BRIEF DESCRIPTION OF THE DRAWINGS

FIGS. 1A and 1B illustrate examples of a bidirectional ring and two-dimensional (2D) Mesh Network on Chip (NoC) topologies.

FIG. 2 illustrates an example of XY routing in a NoC having a two-dimensional mesh topology.

FIG. 3 illustrates a schematic representation of a NoC implementing coordinate-based routing, in accordance with an example implementation.

FIG. 4 illustrates a flowchart of an example method of designing a NoC with optimized coordinate-based routing, in accordance with an example implementation.

FIGS. 5A and 5B illustrate example representations of aligned sequences identified from the NoC of FIG. 3, in accordance with an example implementation.

FIGS. 6A and 6B illustrate graphs representing example order dependencies between the aligned sequences, in accordance with an example implementation.

FIG. 7 illustrates an example computer/server block diagram upon which the example implementations described herein may be implemented.

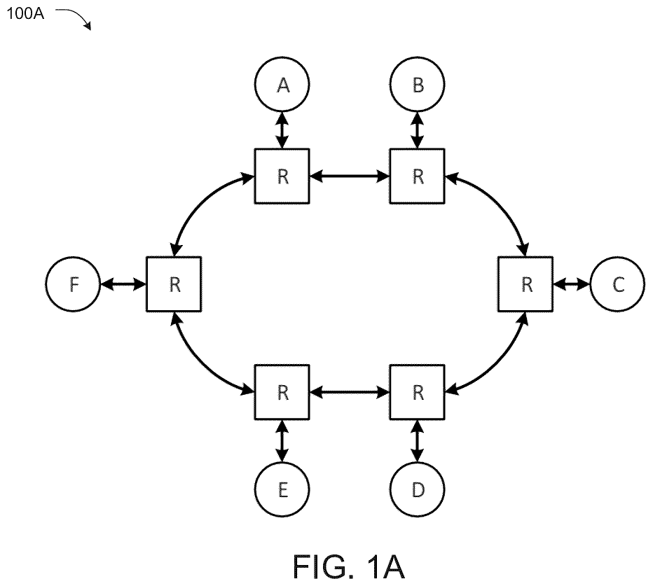

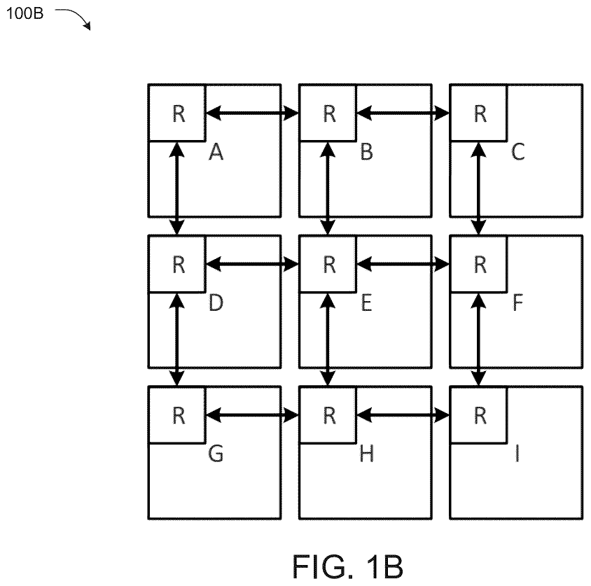

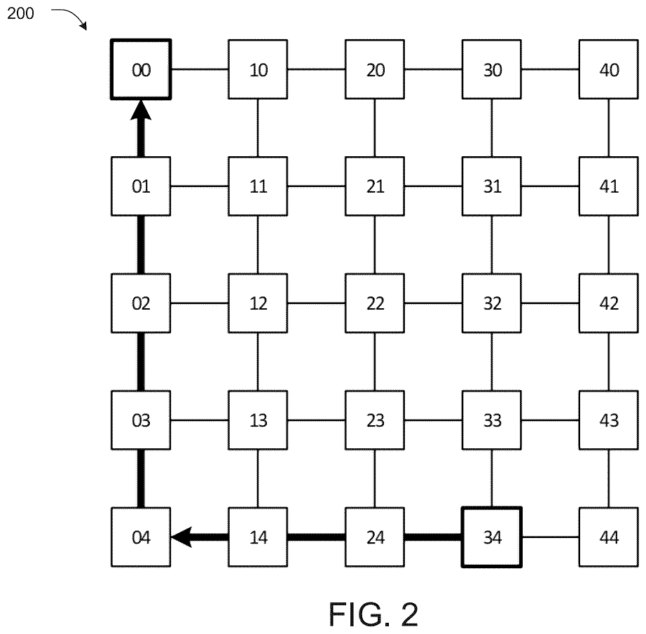

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic implementations (within a computing device or a computer system) or semi-automatic implementations involving user or administrator control over certain aspects of the implementation (through inputs provided using a user interface or the computing devices/system), depending on the desired implementation of one of ordinary skill in the art practicing implementations of the present application.

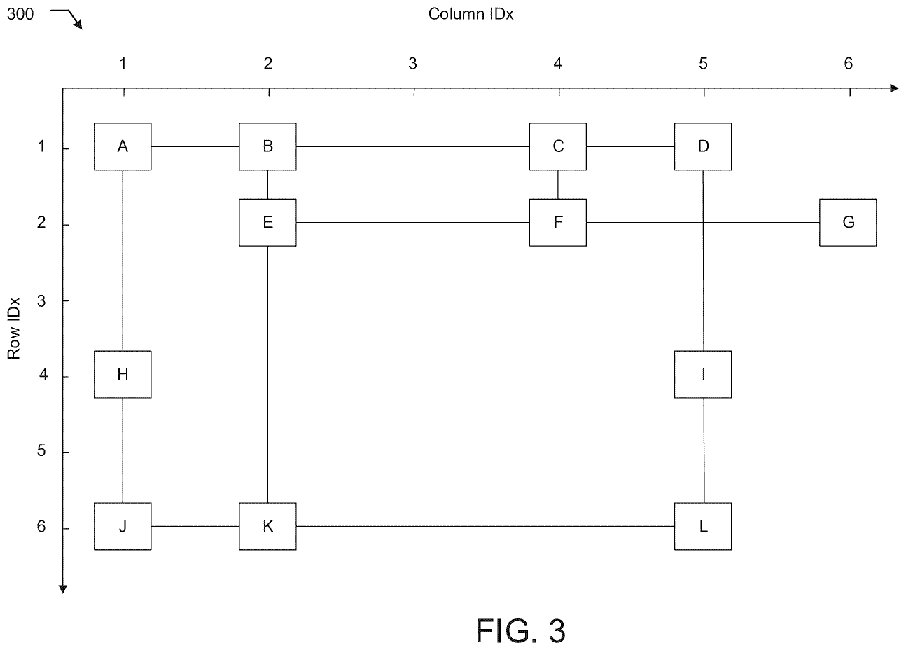

Many Network-on-Chips (NoC) (or sub-NoCs which collectively form the NoC) are designed on a grid or a mesh topology, i.e., one or more NoC elements (such as routers and/or bridges) of the NoC/sub-NoC are connected by links in a grid/mesh topology. As shown in FIG. 3, designers may define the NoC (such as NoC 300) by placing one or more NoC elements (such as routers A to I) on connection points of a rectangular grid, to enable each NoC element to be identified by a row coordinate/index and a column coordinate/index. Examples of NoC elements may include routers, bridges, and the like. While the NoC 300 shown in FIG. 3 may be defined on a 6×6 rectangular grid, however, it may be appreciated that the NoC may be defined on a grid of any size/dimension. Further, it may be noted that while the rectangular grid defines 36 unique positions/connection points for placing the NoC elements, only a subset of the available positions may be used. Each of the NoC elements may be configured to communicate with other NoC elements through XY or YX routing (i.e., routing messages/data packets either through links in the horizontal or vertical directions).

For example, a source node (such as a processing element) connected to the router A may be configured to communicate with a destination node (which may be another processing element) associated with the router L through a path formed by links between the routers B, C, D, and I. Data packets may be injected into the router A by the source node, which may direct the packets in an eastward direction until the data packet reaches the router D (or column index 5), where the data packets may be turned or be directed in a southward direction until the data packets reach the router L (or row index 6). Then, the data packets may be ejected to the destination node from the router L.

NoCs may also be designed to have other topologies having multiple parallel lines providing connection points where the NoC elements can be placed at intersection points thereof. The parallel lines may be in two or more dimensions. Further, NoCs may also be designed to have a torus topologies. In such topologies, the NoC elements may be arranged in a manner that allows the NoC elements to be identifiable using coordinate points in one or more coordinate dimensions, and also where at least one subset of the NoC elements is collinear, i.e., aligned/align-able in a substantially linear set of links extending along a corresponding coordinate dimension thereof. Such NoCs may also use coordinate-based routing algorithms.

Under coordinate-based routing, paths/routes to be used by the data packets for communication between each pair of nodes/NoC elements may be predefined during the construction of the NoC. Further, the routes may also be transmitted along with or within the data packets, to allow intermediate routers to direct the data packets in the appropriate direction. In implementations where the NoC has a mesh topology, the routers may be identified by the row and column indices. Assuming the NoC 300 implements an XY and/or YX routing pattern, the paths/routes may be defined by the destination coordinates. For example, given the NoC 300 is defined on a 6×6 rectangular grid, the path between the source node (S₁) associated with router A and the destination node (D₁) associated with router L may be represented as P₁ (A L)=(5, 6), where ‘P’ refers to path/route, 5 instructs the NoC to route to column 5 and then 6 instructs the NoC to route to row 6.

However, the size of the paths/routes increases based on the size of the rectangular grid (which in turn determines the size/width of the column and/or row indices). Particularly, the size of the widths may be defined as Route_{width}=2*coordinate_idx_{width}, where Route_{width} refers to the width of the route, coordinate_idx_{width} refers to the width or number of bits used to represent the coordinate (i.e., row and column) indices. Hence, as the size of grid increases, the cost and complexity of identifying and storing the routes also increases. In many designs, each of the routers may not be connected to every neighboring NoC element thereof (i.e., other NoC elements in northern, southern, eastern, and western directions at any distance from the NoC element), which may be due to lack of any communication required between the nodes associated with such routers. Accordingly, to reduce costs, links may not be provided to connect such routers, thereby providing the NoC with a heterogeneous/irregular design. However, for NoCs with irregular grid arrangements (i.e., where routers are not provided at every coordinate point and where links are not provided in every direction of the routers), more complex routing schemes may be used to retain the benefits of coordinate-based routing while supporting multi-turn paths (for example, between the routers H/J and the router G).

In some existing solutions, the number of coordinate indices used to represent the NoC is reduced, by ignoring/discarding rows and columns having only unused/unrealized NoC elements/routers for assigning the coordinate indices. For example, row indices 3 and 5 may be discarded such that the count of row indices is reduced to ‘4’. Similarly, column index 3 may be discarded to reduce the count of column indices to ‘5’. Lowering the count of row/column indices may allow a smaller number of bits to be used to represent the coordinate indices. However, such optimizations are insufficient, as they are dependent on there being unrealized connection points for routers. As size and complexity of the NoC increases, the chances of having coordinate dimensions with no realized coordinate points for NoC elements/routers decreases.

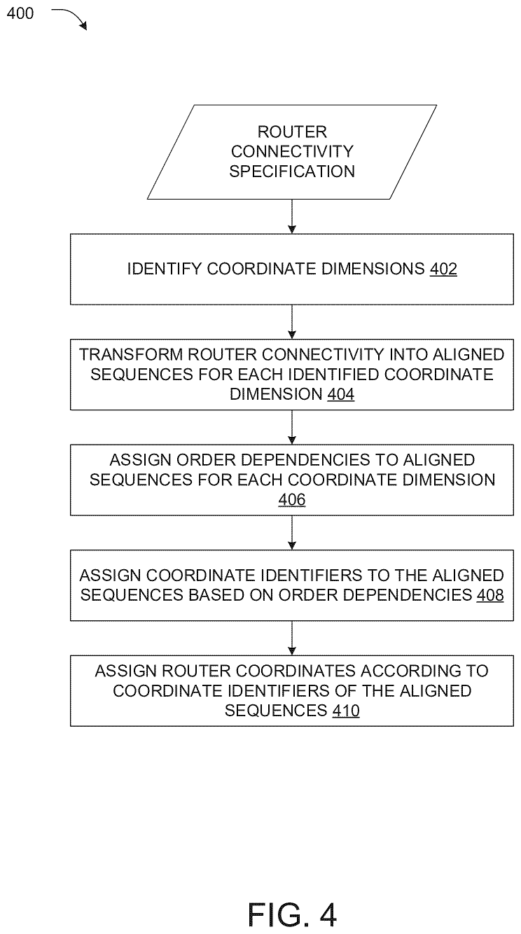

Hence, the present disclosure seeks to further optimize sizes of the routes/paths. The present disclosure provides a method, a system, and a non-transitory computer-readable medium storing instructions for designing a NoC implementing an optimized coordinate-based routing. The method includes identifying coordinate dimensions of a NoC, and transforming router connectivity of the NoC into aligned sequences for each coordinate dimension. Then, the method includes assigning order dependencies to the aligned sequences for each coordinate dimension, and assigning coordinate identifiers to the aligned sequences based on the order dependencies. Further, the method includes assigning router coordinates according to the coordinate identifiers of the aligned sequences. Assigning router coordinates based on the order dependencies of the aligned sequences reduces the size of routes/paths between routers, thereby optimally utilizing the capabilities of the NoC and/or reducing cost. Various embodiments of the present disclosure are described in detail in reference to FIGS. 4 to 7.

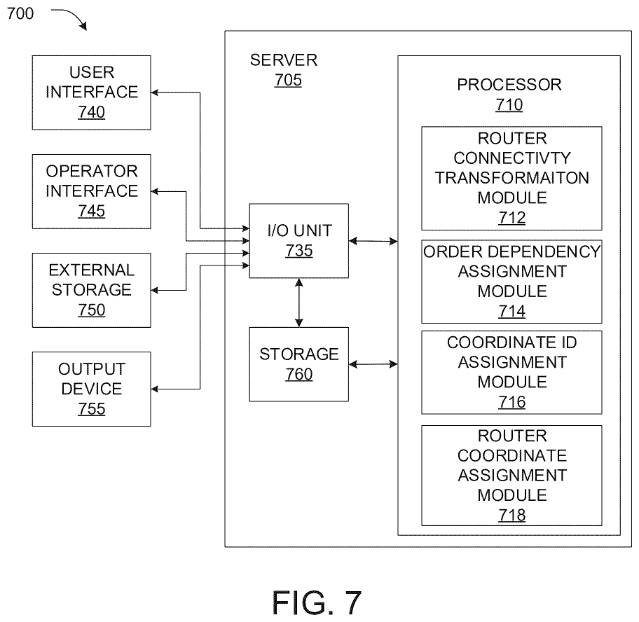

Referring to FIG. 4, a method 400 of (automatically) designing for a NoC is shown. In some embodiments, the method 400 may be implemented using a computing device/server/computing system/processor, such as those described in FIG. 7.

At step 402, the method 400 includes identifying coordinate dimensions of a NoC. The coordinate dimensions may be identified based on the topology of the NoC, as defined in a router connectivity specification provided by a designer of the NoC. For example, the method 400 may include identifying that the NoC 300 of FIG. 3 includes two dimensions (viz., X/row/first and Y/column/second dimensions). The router connectivity specification may uniquely identify each of the NoC elements/routers and the positions thereof in the grid/mesh topology. For example, the routers of the NoC 300 are labelled from A to L. While embodiments of the present disclosure are described in the context of two-dimensional grids, it may be appreciated that the method 400 may be suitably adapted for 3 or more (n) dimensional grid/mesh topology. Further, the method 400 may also be adapted for other topologies, such as torus or other wrapped mesh topologies, and also triangular or other topologies formed by overlapping sets of parallel lines and making vertices at intersections.

At step 404, the method 400 includes transforming the router connectivity (specification) of the NoC into aligned sequences for each (identified) coordinate dimension. The aligned sequences may be obtained by listing the NoC elements/routers in groups/lists for each value along one of the coordinate dimensions. For example, each of the routers provided along a first value or coordinate along a first dimension (such as row dimension of X axis) of the NoC may be listed in a first aligned sequence (which may include the routers A, B, C, and D), the routers provided along a second value of the first dimension may be listed in a second aligned sequence (which may include the routers E, F, and G), and so on. Further, each router listed in the corresponding aligned sequences may be connected to the adjacent (i.e., succeeding or preceding) router thereof. In some embodiments, each aligned sequence may include a set of routers that are either horizontally or vertically connected along each value/point on each dimension (i.e., each row or column for NoC 300). Separate aligned sequences may be created for the routers that are associated with one of the values of the coordinate dimension, but are disjoint or not connected by links. For example, while the routers H and I are associated with the value 4 on the first dimension (i.e., the row dimension), two separate aligned sequences may be created for the routers H and I due to a lack of links/connections therebetween.

In some embodiments, a subset of routers connected to either the first or the last router listed in the aligned sequence in a different dimension may be ‘turned’ or ‘straightened,’ such that the subset of routers align with the first or the last router of the aligned sequence in the same dimension as the dimension associated with the aligned sequence. In such embodiments, the subset of routers may be included with the same aligned sequence as the first/last router after turning/straightening. For example, if the router G had a subset of routers having at least one router extending therefrom in the second dimension (i.e., the column dimension), and further routers extending from the at least one router in any dimension, all of the routers being connected to each other in a sequential path, such subset of routers may be turned or straightened to linearly extend from the router G in the first dimension, thereby allowing the subset of routers to be included in the same aligned sequence as that of the router G.

Further, the routers of the aligned sequences may be listed in the order in which they appear along the values of the coordinate dimension. In some examples, the routers from left-most end to the right-most end (from the perspective of FIG. 3), or vice-versa, may be listed in the aligned sequences corresponding to the first dimension. For instance, a first aligned sequence may be represented as a list having the routers in the order [A, B, C, D], given the router A is the left-most or the first element and the router D is the right-most or the last element in the row/first dimension. Similarly, the routers may be listed from top-most end to bottom-most end (from the perspective of FIG. 3), or vice-versa, in the aligned sequences corresponding to the second dimension (i.e., on column dimension or Y axis). For instance, a second aligned sequence in the second dimension may be represented as a list having routers [A, H, J], in that order.

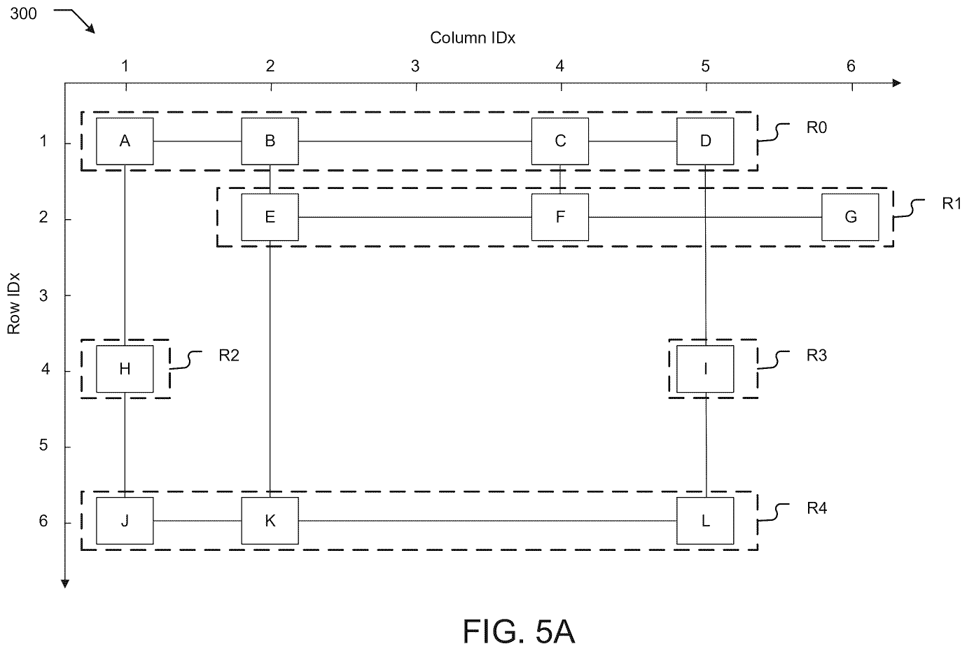

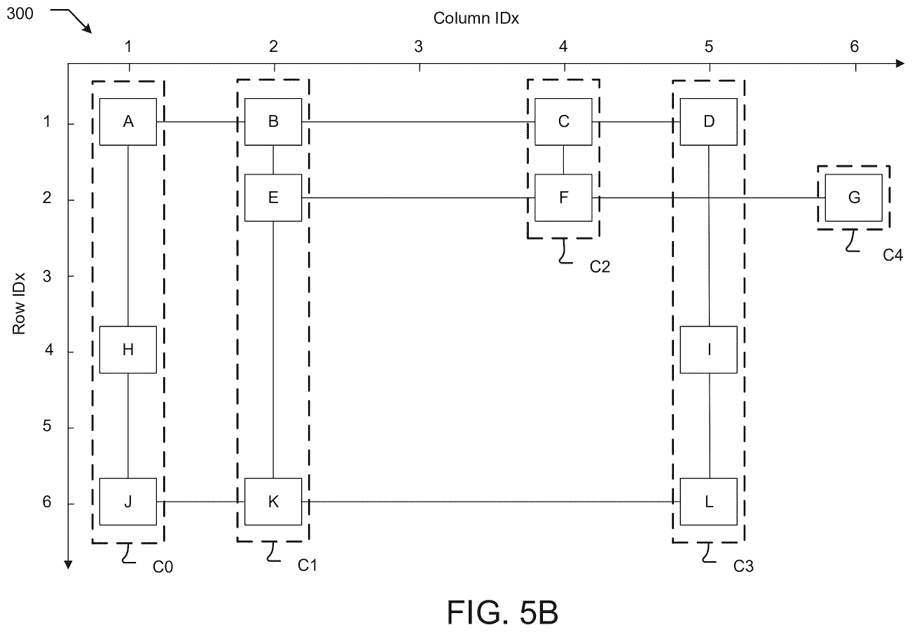

FIGS. 5A and 5B show the aligned sequences obtained from the router connectivity specification associated with NoC design/NoC 300. FIG. 5A shows the aligned sequences formed along the first dimension, which include ‘row’ groups or ‘row’ aligned sequences:
[A, B, C, D]-R0
[E, F, G]-R1
[H]-R2
[I]-R3
[J, K, L]-R4

Similarly, FIG. 5B shows the aligned sequences formed along the second dimension, which include ‘column’ groups or ‘column’ aligned sequences:
[A, H, J]-C0
[B, E, K]-C1
[C, F]-C2
[D, I, L]-C3
[G]-C4

In some embodiments, a coordinate index/identifier may be assigned to each of the aligned sequences in each dimension, which is represented by Rₖ and Cₗ, where ‘k’ refers to the row index or index of the aligned sequence in the first dimension, and ‘l’ refers to the column index or index of the aligned sequence in the second dimension. Hence, each of the routers (and coordinates within the mesh topology) may be identified by two coordinate indices, each associated with a corresponding aligned sequence.

Returning to FIG. 4, at step 406, the method 400 includes assigning order dependencies to the aligned sequences for each of the coordinate dimensions. In some embodiments, the order dependencies for each coordinate dimension may be assigned based on order of appearance of each router/element in the aligned sequences associated with other coordinate dimensions. For example, the order dependencies for the aligned sequences associated with the row dimension or the first dimension may be determined based on order/sequence of the corresponding router in the aligned sequences associated with other dimensions, such as the column dimension or the second dimension. The order dependencies may indicate the coordinate value to be provided to each of the aligned sequences. For example, in aligned sequence C0 in the column dimension, router H is listed after router A, which implies that the aligned sequence R2 having the router H is to be assigned a higher/greater/larger coordinate identifier than the aligned sequence R0 having router A. Similarly, in aligned sequence R0 in the row dimension, router A is listed before router B, which implies that the aligned sequence C1 having router B is assigned a higher coordinate identifier than the aligned sequence C0 having router A.

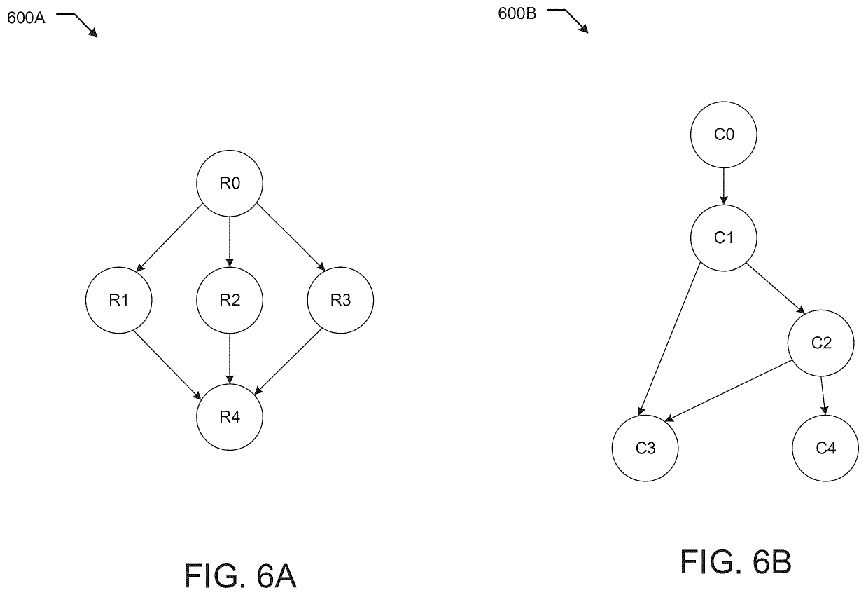

Further, the order dependencies may be added between the aligned sequences in each dimension, along one direction. For example, to compare the adjacent elements/routers, aligned sequences R0 to R4 may be selected based on the order in which the aligned sequences R0 to R4 appear in either north-to-south direction or south-to-north direction. In such examples, each adjacent elements/routers in aligned sequence R0 may be compared to add order dependencies to the aligned sequences C0 to C4, before comparing the adjacent elements/routers in aligned sequence R1, and so on. Similarly, to compare the adjacent elements/routers, aligned sequences C0 to C4 may be selected based on the order in which the aligned sequences C0 to C4 appear in either east-to-west direction or west-to-east direction. In such examples, each adjacent elements/routers in aligned sequence C0 may be compared to add order dependencies to the aligned sequences C0 to C6, before comparing the adjacent elements/routers in aligned sequence R1, and so on. The order dependencies assigned to the aligned sequences in the foregoing examples are represented by graphs 600A and 600B shown in FIGS. 6A and 6B, respectively. In the graphs 600A, 600B, the nodes (represented by circles) correspond to the aligned sequences, and the directed edges correspond to the order dependencies thereof. The graphs 600A, 600B generated may be acyclic, thereby allowing for topological sorting of the aligned sequences.

At step 408, the method 400 includes assigning coordinate identifiers to the aligned sequences based on the order dependencies. In some embodiments, the coordinate identifiers may be assigned to the aligned sequences based on a hierarchy depth of the aligned sequences from topology generations of the order dependencies. In some embodiments, the ordering dependencies, when represented in the form of a graph, may be topologically sorted to obtain a linear ordering, based on which the coordinate identifiers may be assigned to the aligned sequences, in each dimension. For example, for the aligned sequences in the first dimension, the linear ordering obtained for topological sorting of the graph 600A in FIG. 6A may be (R0) (R1,R2,R3) (R4). The topological sorting of the order dependencies indicates the different levels/depths of hierarchy or ordering of the aligned sequences in at least one of the coordinate dimensions. The coordinate identifiers may be assigned to the aligned sequences according to the level/position/depth of the aligned sequence in the hierarchy. As shown in FIG. 6A, the order dependencies may indicate that the aligned sequence R0 may be assigned a lower coordinate identifier that aligned sequences R1, R2, and R3, and the aligned sequences R1, R2, and R3 may be assigned a lower coordinate identifier that aligned sequence R4. Accordingly, the aligned sequence R0 may be assigned the coordinate identifier ‘0’, aligned sequences R1, R2, and R3 may be assigned coordinate identifier ‘1’, and the aligned sequence R4 may be assigned the coordinate identifier ‘2’, corresponding to the levels/position of the corresponding aligned sequences in the hierarchy.

Similarly, the linear ordering obtained for topological sorting of the graph 600B in FIG. 6B may be (C0) (C1) (C2) (C3,C4). According to the order dependencies, the aligned sequence C0 may be assigned the coordinate ID ‘0’, the aligned sequence C1 may be assigned the coordinate ID ‘1’, the aligned sequence C2 may be assigned the coordinate ID ‘2’, and the aligned sequences C3 and C4 may be assigned the coordinate ID ‘3’.

At step 410, the method 400 includes assigning router coordinates according to the coordinate identifiers of the aligned sequences. Each of the routers may be assigned router coordinates based on the coordinate identifiers assigned to the aligned sequences to which the router belongs. For example, router A belonging to the aligned sequences R0 and C0 may be assigned router coordinates (0, 0), router G may be assigned the router coordinates (1, 3), and so on for other routers.

Once the router coordinates are assigned, the paths/routes may be identified and/or defined between the routers. The routes may include the router coordinates of the destination router. In some embodiments, the paths/routes may then be provided/stored in registers associated with the routers/nodes associated with routers for transmission of the data packets after construction of the NoC. The NoC may be constructed or manufactured, such that the routers of the constructed NoC are configured to use the destination router coordinates (as determined by the method 400) for routing packets through the NoC. The paths/routes having the destination router coordinates may be transmitted along with the data packets (either in separate/parallel links/channels, or within the data packets transmitted through main-band data paths),

Using coordinate identifiers to determine the router coordinates based on order dependencies of aligned sequences derived from the router connectivity enables the paths/routes to be defined with a lower number of bits in comparison to existing solutions. As indicated in the foregoing example, the count of the unique coordinate identifiers of the aligned sequences for the row/first dimension and column/second dimension are 3 and 4, while existing solutions require 4 and 5 identifiers for the first and second dimensions, respectively, thereby saving at least one bit in at least one of the coordinate dimensions. It may be appreciated that the number bits saved may increase as the size and coarse-ness/complexity of the NoC increases. Further, in cases where the NoC elements are slightly offset from other NoC elements connected horizontally or vertically thereto during the design or the physical implementation/realization of the NoC, such horizontally/vertically connected NoCs may be assigned the same aligned sequences (assuming other conditions are adhered to), thereby minimizing the size of router coordinates. Hence, lowering the size of the routes may have design implications, which may be exploited for further optimizing the design, construction, and operation of the NoC.

Reducing the number of bits for conveying routing information may be useful in control networks, such as those used for debugging, traceability, and the like, among others. Control networks (formed by a set of control links) may be used to convey routing information, among others, along with other data packets being transmitted in parallel in corresponding data networks/paths. Control networks may increase bandwidth and reduce latency of the NoC, by providing dedicated paths for conveying routing information, traceability information, and the like. Being able to reduce the size of the routes/routing information enables bandwidth of the control links to be optimally utilized, or reduced to alleviate costs.

Reducing the number of bits required for routing may also allow the capacities of the routers and the links to be optimally utilized. Either the saved bits may be used to provide other functionality, or the cost of NoC may be reduced by utilizing links and routers that are cheaper (i.e., operate on a smaller number of bits). For example, the bits saved may essentially mean that every link between any two pair of routers (in all directions), and every channel (such as read request channels, write request changes, read response channels, write response channels, and so on) associated with the link can carry a lesser number of bits, thereby reducing costs, without increasing the complexity of routing. Assigning the router coordinates based on the order dependencies of the aligned sequences reduces the size of routing paths without losing information, thereby requiring no change in routing algorithms/implementations.

While embodiments of the present disclosure are described in the context of the NoC being defined on a rectangular grid, it may be appreciated that the method 400 and systems implementing the method 400 may be suitably adapted for implementation in other kinds of grids used for constructing the NoC as well. In some embodiments, the method 400 may be adapted for implementation on a NoC having an n-dimensional mesh topology, for an n greater than two. In such embodiments, the order dependencies may be identified for each of the n-dimensions, with respect to at least one other coordinate dimension of the NoC. In some embodiments, an order dependency along a dimension is added from a first aligned sequence of the aligned sequences to a second aligned sequence of the aligned sequence when there is an element of the first aligned sequence adjacent to an element of the second aligned sequence within a third-dimension sequence, the third-dimension sequence being a third aligned sequence from the aligned sequences associated with a coordinate dimension that is different from that of the first and the second aligned sequences. In some embodiments, the method 400 may be adapted for implementation on a NoC having a torus or other wrapped mesh topology. In such embodiments, the routers in each of the aligned sequences may have a circular or cyclical relationship, where the first router in each aligned sequence may have an order dependency associated with the last router in the aligned sequence. In further embodiments, the method 400 may be adapted for implementation on a NoC having a triangular or other topology formed by overlapping sets of parallel lines and making

### Vertices at Intersections.

The method 400 of the present disclosure may be implemented in a computer/computing device or system. FIG. 7 illustrates an example computer system 700 on which example embodiments may be implemented. The computer system 700 includes a computing device/server 705 which may include an I/O unit 735, storage 760, and a processor 710 operable to execute one or more units as known to one of skill in the art. The term “computer-readable medium” as used herein refers to any medium that participates in providing instructions to processor 710 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include transitory media such as carrier waves. The I/O unit 735 processes input from user interfaces 740 and operator interfaces 745 which may utilize input devices such as a keyboard, mouse, touch device, or verbal command.

The server 705 may also be connected to an external storage 750, which may contain removable storage such as a portable hard drive, optical media (CD or DVD), disk media, or any other medium from which a computer can read executable code. The server 705 may also be connected to an output device 755, such as a display to output data and other information to a user, as well as request additional information from a user. The connections from the server 705 to the user interface 740, the operator interface 745, the external storage 750, and the output device 755 may be via wireless protocols, such as the 802.11 standards, Bluetooth® or cellular protocols, or via physical transmission media, such as cables or fiber optics. The output device 755 may therefore further act as an input device for interacting with a user. The processor 710 may be configured to execute any one or a combination of a router connectivity transformation module 712, an order dependency assignment module 714, a coordinate identifier (ID) assignment module 716, and a router coordinate assignment module 718. The router connectivity transformation module 712 may be configured to identify coordinate dimensions of the NoC (such as NoC 300) transform the router connectivity of the NoC into aligned sequences for each coordinate dimension. The order dependency assignment module 714 may be configured to assign order dependencies to the aligned sequences for each coordinate dimension. The order dependency may be represented as a topological hierarchy. In some embodiments, an order dependency is added from a first aligned sequence of the aligned sequences to a second aligned sequence of the aligned sequence when there is an element of the first aligned sequence adjacent to an element of the second aligned sequence within a third-dimension sequence. The coordinate ID assignment module 716 may be configured to assign coordinate identifiers to the aligned sequences based on the order dependencies. The coordinate identifiers may be assigned to the aligned sequences based on a hierarchy depth of the aligned sequences from topology generations of the order dependencies. The router coordinates assignment module 718 may be configured to assign router coordinates according to the coordinate identifiers of the aligned sequences. In some embodiments, instructions to optimize the coordinate-based routing of NoCs (as described in reference to the method 400 and the modules executed by the processor 710) may be stored in a computer-readable medium.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example embodiments, the steps carried out require physical manipulations of tangible quantities for achieving a tangible result.

Moreover, other implementations of the example embodiments will be apparent to those skilled in the art from consideration of the specification and practice of the example embodiments disclosed herein. Various aspects and/or components of the described example embodiments may be used singly or in any combination. It is intended that the specification and examples be considered as examples, with a true scope and spirit of the embodiments being indicated by the following claims.

What is claimed is:

1. A method of designing for a Network on Chip (NoC), comprising:
identifying coordinate dimensions of a NoC;
transforming router connectivity of the NoC into aligned sequences for each coordinate dimension;
assigning order dependencies to the aligned sequences for the each coordinate dimension;
assigning coordinate identifiers to the aligned sequences based on the order dependencies; and
assigning router coordinates according to the coordinate identifiers of the aligned sequences.

2. The method of claim 1, wherein an order dependency is added from a first aligned sequence of the aligned sequences to a second aligned sequence of the aligned sequence when there is an element of the first aligned sequence adjacent to an element of the second aligned sequence within a third-dimension sequence.

3. The method of claim 1, wherein the assigning coordinate identifiers to the aligned sequences based on the order dependencies is conducted based on a hierarchy depth of the aligned sequences from topology generations of the order dependencies.

4. The method of claim 1, wherein the NoC comprises a grid or two-dimensional mesh topology.

5. The method of claim 1, wherein the NoC comprises an n-dimensional mesh topology for an n greater than two.

6. The method of claim 1, wherein the NoC comprises a torus or other wrapped mesh topology.

7. The method of claim 1, wherein the NoC comprises a triangular or other topology formed by overlapping sets of parallel lines and making vertices at intersections.

8. A system comprising a processor, configured to:
identify coordinate dimensions of a NoC;
transform router connectivity of the NoC into aligned sequences for each coordinate dimension;
assign order dependencies to the aligned sequences for the each coordinate dimension;
assign coordinate identifiers to the aligned sequences based on the order dependencies; and
assign router coordinates according to the coordinate identifiers of the aligned sequences.

9. The system of claim 8, wherein an order dependency is added from a first aligned sequence of the aligned sequences to a second aligned sequence of the aligned sequence when there is an element of the first aligned sequence adjacent to an element of the second aligned sequence within a third-dimension sequence.

10. The system of claim 8, wherein the coordinate identifiers are assigned to the aligned sequences based on a hierarchy depth of the aligned sequences from topology generations of the order dependencies.

11. The system of claim 8, wherein the NoC comprises a grid or two-dimensional mesh topology.

12. The system of claim 8, wherein the NoC comprises an n-dimensional mesh topology for an n greater than two.

13. The system of claim 8, wherein the NoC comprises a torus or other wrapped mesh topology.

14. The system of claim 8, wherein the NoC comprises a triangular or other topology formed by overlapping sets of parallel lines and making vertices at intersections.

15. A non-transitory computer-readable medium storing instructions for designing a Network on Chip (NoC), the instructions comprising:
identifying coordinate dimensions of a NoC;
transforming router connectivity of the NoC into aligned sequences for each coordinate dimension;
assigning order dependencies to the aligned sequences for the each coordinate dimension;
assigning coordinate identifiers to the aligned sequences based on the order dependencies; and
assigning router coordinates according to the coordinate identifiers of the aligned sequences.

16. The non-transitory computer-readable medium of claim 15, wherein an order dependency is added from a first aligned sequence of the aligned sequences to a second aligned sequence of the aligned sequence when there is an element of the first aligned sequence adjacent to an element of the second aligned sequence within a third-dimension sequence.

17. The non-transitory computer-readable medium of claim 15, wherein the assigning coordinate identifiers to the aligned sequences based on the order dependencies is conducted based on a hierarchy depth of the aligned sequences from topology generations of the order dependencies.

18. The non-transitory computer-readable medium of claim 15, wherein the NoC comprises a grid or two-dimensional mesh topology.

19. The non-transitory computer-readable medium of claim 15, wherein the NoC comprises an n-dimensional mesh topology for an n greater than two.

20. The non-transitory computer-readable medium of claim 15, wherein the NoC comprises a torus or other wrapped mesh topology, or wherein the NoC comprises a triangular or other topology formed by overlapping sets of parallel lines and making vertices at intersections.
